(19) United States
(12) Patent Application Publication
(10) Pub. No.: US 2026/0067959 A1
(43) Pub. Date: Mar. 5, 2026

(54) ELECTRONIC APPARATUS, COMMUNICATION METHOD, AND NON-TRANSITORY COMPUTER-READABLE STORAGE MEDIUM STORING PROGRAM

(71) Applicant: SEIKO EPSON CORPORATION, Tokyo (JP)

(72) Inventor: Kazuki YANAGISAWA, Shiojiri (JP)

(21) Appl. No.: 19/311,051

(22) Filed: Aug. 27, 2025

(30) Foreign Application Priority Data
Aug. 29, 2024 (JP) 2024-147116

(51) Int. Cl. H04W 76/14; H04W 4/80; H04W 52/02; H04W 84/12

(52) U.S. Cl. CPC H04W 76/14; H04W 4/80; H04W 52/0261; H04W 84/12

(57) ABSTRACT

A first electronic apparatus includes a controller and a first communication section that executes Wi-Fi Aware communication when Wi-Fi Aware coupling by a Wi-Fi Aware function is established between the first electronic apparatus and a second electronic apparatus. When the first electronic apparatus is in a first state related to power consumption, the controller stands by for coupling in a state where the Wi-Fi Aware function is enabled. When the first electronic apparatus is in a second state predetermined as a state where power consumption is to be reduced more than in the first state, the controller stands by for coupling in a state where a Bluetooth Low Energy Triggers NAN function is enabled. When the first electronic apparatus acquires a request to activate the Wi-Fi Aware function, the controller stands by for coupling in a state where the Wi-Fi Aware function is enabled.

The present application is based on, and claims priority from JP Application Serial Number 2024-147116, filed Aug. 29, 2024, the disclosure of which is hereby incorporated by reference herein in its entirety.

### BACKGROUND

### 1. Technical Field

The present disclosure relates to an electronic apparatus, a communication method, and a non-transitory computer-readable storage medium storing a program.

### 2. Related Art

JP-A-2019-134322 discloses a process of establishing Wi-Fi (registered trademark, the same applies hereinafter) Aware coupling.

However, according to the technique described in JP-A-2019-134322, since the apparatus is on standby in a Wi-Fi enabled state during execution of service discovery, power is consumed even during standby.

Therefore, it is desirable to develop a technique for reducing power consumption of an electronic apparatus in a standby state for performing Wi-Fi Aware coupling to another electronic apparatus.

### SUMMARY

According to an aspect of the present disclosure, an electronic apparatus includes a communication section that communicates with another electronic apparatus by Wi-Fi Aware communication, and a controller. The controller stands by for coupling in a state where a Wi-Fi Aware function is enabled when the electronic apparatus is in a first state related to power consumption. The controller stands by for coupling in a state where a Bluetooth Low Energy Triggers Neighbor Awareness Networking (NAN) function is enabled when the electronic apparatus is in a second state predetermined as a state where power consumption is to be reduced more than in the first state, and stands by for coupling in a state where the Wi-Fi Aware function is enabled when the electronic apparatus acquires a request to activate the Wi-Fi Aware function. The communication section executes the Wi-Fi Aware communication when Wi-Fi Aware coupling by the Wi-Fi Aware function is established between the electronic apparatus and the other electronic apparatus. Bluetooth is a registered trademark, and the same applies hereinafter.

According to another aspect of the present disclosure, a communication method includes causing an electronic apparatus including a communication section that communicates with another electronic apparatus by Wi-Fi Aware communication to: stand by for coupling in a state where a Wi-Fi Aware function is enabled when the electronic apparatus is in a first state related to power consumption; stand by for coupling in a state where a Bluetooth Low Energy Triggers Neighbor Awareness Networking (NAN) function is enabled when the electronic apparatus is in a second state predetermined as a state where power consumption is to be reduced more than in the first state, and stand by for coupling in a state where the Wi-Fi Aware function is enabled when the electronic apparatus acquires a request to activate the Wi-Fi Aware function; and cause the communication section to execute the Wi-Fi Aware communication when Wi-Fi Aware coupling by the Wi-Fi Aware function is established between the electronic apparatus and the other electronic apparatus.

According to still another aspect of the present disclosure, a non-transitory computer-readable storage medium storing a program that causes a computer included in an electronic apparatus including a communication section that communicates with another electronic apparatus by Wi-Fi Aware communication to execute a process of: causing the electronic apparatus to stand by for coupling in a state where a Wi-Fi Aware function is enabled when the electronic apparatus is in a first state related to power consumption; causing the electronic apparatus to stand by for coupling in a state where a Bluetooth Low Energy Triggers Neighbor Awareness Networking (NAN) function is enabled when the electronic apparatus is in a second state predetermined as a state where power consumption is to be reduced more than in the first state, and stand by for coupling in a state where the Wi-Fi Aware function is enabled when the electronic apparatus acquires a request to activate the Wi-Fi Aware function; and causing the communication section to execute the Wi-Fi Aware communication when Wi-Fi Aware coupling by the Wi-Fi Aware function is established between the electronic apparatus and the other electronic apparatus.

### BRIEF DESCRIPTION OF THE DRAWINGS

FIG. 1 is a block diagram illustrating an example of a configuration of a communication system according to an embodiment.

FIG. 2 is a flowchart for explaining an example of a communication process executed in a first electronic apparatus included in the communication system illustrated in FIG. 1.

FIG. 3 is a flowchart for explaining an example of coupling standby processing in a state where Wi-Fi Aware is on in the communication process illustrated in FIG. 2.

FIG. 4 is a flowchart for explaining an example of coupling standby processing with Bluetooth Low Energy Triggers NAN in the communication process illustrated in FIG. 2.

FIG. 5 is a diagram illustrating an example of a hardware configuration of each of the apparatus and another apparatus.

### DESCRIPTION OF EMBODIMENTS

Hereinafter, embodiments of the present disclosure will be described with reference to the drawings. The drawings are merely examples for explaining the embodiments of the present disclosure. Furthermore, not all components described in the embodiments of the present disclosure are necessarily essential in the present disclosure.

### EMBODIMENTS

### System Configuration

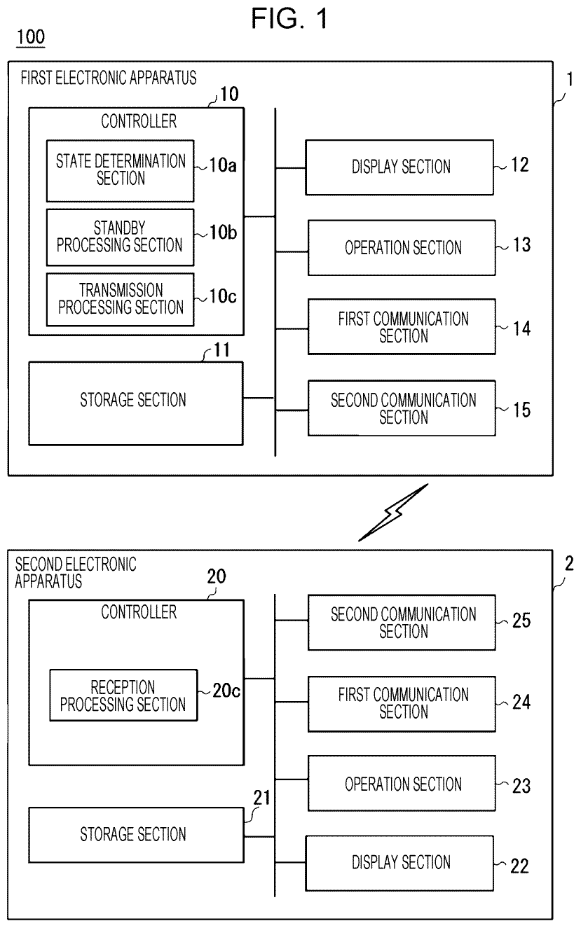

A communication system including an electronic apparatus according to the present embodiment and another electronic apparatus will be described with reference to FIG. 1. FIG. 1 is a block diagram illustrating an example of a configuration of the communication system.

As illustrated in FIG. 1, the communication system 100 according to the present embodiment includes a first electronic apparatus 1 and a second electronic apparatus 2. The first electronic apparatus 1 is an example of an electronic apparatus, and may be, for example, an image forming apparatus or an information processing apparatus. The second electronic apparatus 2 is an example of another electronic apparatus, and may be, for example, an information processing apparatus or an image forming apparatus.

Each of the image forming apparatuses may be a printer, a scanner, a facsimile machine, a multifunction peripheral having a plurality of functions including at least an image forming function, or the like. In addition, in a case where each of the image forming apparatuses is an apparatus that forms an image on a medium, that is, a printing apparatus, a printing method of the apparatus is not particularly limited, and for example, various printing methods such as an ink jet printing method and a laser printing method can be applied as the printing method of the apparatus. Each of the information processing apparatuses may be an information processing apparatus such as a personal computer (PC), a smartphone, or a tablet terminal.

The communication system 100 is a system in which an electronic apparatus exemplified as the first electronic apparatus 1 can perform Wi-Fi Aware communication with the other electronic apparatus exemplified as the second electronic apparatus 2 in response to a request for Wi-Fi Aware coupling from the other electronic apparatus. For example, in a case where the first electronic apparatus 1 is an image forming apparatus and the second electronic apparatus 2 is an information processing apparatus such as a PC, the communication system 100 is constructed as a printing system in which the first electronic apparatus 1 performs printing in response to a print request from the second electronic apparatus 2. Examples of configurations of the first electronic apparatus 1 and the second electronic apparatus 2 will be described below in detail.

### Configuration of First Electronic Apparatus 1

As illustrated in FIG. 1, the first electronic apparatus 1 may include a controller 10, a storage section 11, a display section 12, an operation section 13, a first communication section 14, and a second communication section 15. For example, in a case where the first electronic apparatus 1 is an image forming apparatus, the first electronic apparatus 1 may include a section for implementing a main function of the apparatus, for example, the first electronic apparatus 1 may include a section for image formation.

The controller 10 may include a state determination section 10a and a standby processing section 10b, which will be described later, in order to execute processing of performing Wi-Fi Aware communication with the second electronic apparatus 2 via the first communication section 14. The controller 10 may further include a transmission processing section 10c which will be described later.

The controller 10 may include, for example, an arithmetic processing device such as a CPU or a GPU, a working memory, and a storage device that stores a control program, parameters, and the like. CPU is an abbreviation for Central Processing Unit. GPU is an abbreviation for Graphics Processing Unit. The controller 10 may be configured as a system on a chip (SoC). As can be seen from these examples, the controller 10 may be configured to store the control program in an executable state. However, the controller 10 may be configured to store the control program as a circuit configuration such as a field-programmable gate array (FPGA), or may be configured as a dedicated circuit.

The state determination section 10a, the standby processing section 10b, and the transmission processing section 10c may be implemented as the above-described program. The program may include a program for the arithmetic processing device to implement functions of the state determination section 10a and the standby processing section 10b and a function of the transmission processing section 10c in cooperation with the storage section 11, the display section 12, the operation section 13, the first communication section 14, and the second communication section 15.

The storage section 11 is, for example, a storage device such as a hard disk drive, a solid state drive, or another memory. The storage section 11 may be a section of the storage device in the controller 10. In other words, the storage section 11 may be a section of the controller 10. The storage section 11 can store, for example, setting information necessary for processing in the controller 10, information to be transmitted to the second electronic apparatus 2, and the like.

The display section 12 is a section for displaying a user interface image (UI image) for operating the first electronic apparatus 1, and, for example, is constituted by a display device such as a liquid crystal display or an organic electroluminescence display. Note that the display section 12 may include a display and a drive circuit for driving the display.

The operation section 13 is a section that receives an operation performed by a user of the first electronic apparatus 1, and can also be referred to as an operation receiving section. The operation section 13 can be implemented by, for example, one or more of a physical button, a touch panel mounted on the display section 12, a pointing device, and a keyboard. In a case where the operation section 13 includes the touch panel, the display section 12 and the touch panel may be collectively referred to as an operation panel of the first electronic apparatus 1.

The first communication section 14 is a section capable of communicating with the second electronic apparatus 2 by Neighbor Awareness Networking (NAN) communication, and can be constituted by a communication interface capable of performing the NAN communication. As will be described later, the first electronic apparatus 1 transmits and receives information to and from the second electronic apparatus 2 via a data communication path established by the NAN communication.

The above-described NAN communication is Wi-Fi Aware communication that can be implemented by a Wi-Fi Aware function defined by the Wi-Fi Alliance. That is, the first communication section 14 communicates with the second electronic apparatus 2, which is the other electronic apparatus, by the Wi-Fi Aware communication. Wi-Fi is the name of a wireless LAN (Local Area Network) using the Institute of Electrical and Electronics Engineers (IEEE) 802.11 standard or a derivative standard of the IEEE 802.11 standard.

In addition, the first communication section 14 may be configured to be capable of performing wireless communication with an external apparatus other than Wi-Fi Aware communication. Examples of the external apparatus include an information processing apparatus such as a PC or a smartphone, a server apparatus, and the like. In this case, the information processing apparatus may be the second electronic apparatus 2. In this case, the first communication section 14 may function as a Wi-Fi Aware communication section under control by the controller 10. For example, the first communication section 14 may be a Wi-Fi interface supporting Wi-Fi Aware, and can switch, under control by the controller 10, communication between normal Wi-Fi communication and the Wi-Fi Aware communication in which the first communication section 14 functions as the Wi-Fi Aware communication section. The first electronic apparatus 1 may include a communication interface for communicating with the external apparatus via wired communication.

The second communication section 15 is capable of communicating with the second electronic apparatus 2 by Bluetooth Low Energy communication, and can be constituted by a communication interface capable of performing the Bluetooth Low Energy communication.

The state determination section 10a of the controller 10 determines whether the first electronic apparatus 1 is in a first state related to power consumption or is in a second state predetermined as a state where power consumption is to be reduced more than in the first state.

When the first electronic apparatus 1 is in the first state related to power consumption, the standby processing section 10b of the controller 10 stands by for coupling in a state where the Wi-Fi Aware function is enabled. The standby for coupling in this case refers to standby for the Wi-Fi Aware communication, that is, standby for the Wi-Fi Aware coupling.

When the first electronic apparatus 1 is in the second state, the standby processing section 10b stands by for coupling in a state where a Bluetooth Low Energy Triggers NAN function is enabled. The standby for coupling in this case is standby for the Wi-Fi Aware coupling, but is actually standby for a request to activate the Wi-Fi Aware function. The standby processing section 10b receives the request to activate the Wi-Fi Aware function from the second electronic apparatus 2 via the second communication section 15. Hereinafter, for the sake of simplicity, the Bluetooth Low Energy Triggers NAN function is referred to as a trigger NAN function.

When the standby processing section 10b acquires, via the second communication section 15, the request to activate the Wi-Fi Aware function during standby for coupling in a state where the trigger NAN function is enabled, the standby processing section 10b stands by for coupling in a state where the Wi-Fi Aware function is enabled. The standby for coupling in this case refers to standby for the Wi-Fi Aware coupling.

When the Wi-Fi Aware coupling by the Wi-Fi Aware function is established between the first electronic apparatus 1 and the second electronic apparatus 2, the first communication section 14 executes the Wi-Fi Aware communication.

As described above, the first electronic apparatus 1 switches the standby state for the Wi-Fi Aware coupling according to the state of the first electronic apparatus 1 as follows. That is, when the first electronic apparatus 1 is in the first state where power consumption is not to be reduced, the first electronic apparatus 1 stands by for the Wi-Fi Aware coupling. On the other hand, when the first electronic apparatus 1 is in the second state where power consumption is to be reduced, the first electronic apparatus 1 stands by for coupling in a state where the trigger NAN function is enabled. The first electronic apparatus 1 can reduce power consumption during standby for the Wi-Fi Aware coupling by standing by in the state where the trigger NAN function is enabled, as compared with standby for the Wi-Fi Aware coupling in the first state.

As described above, the first electronic apparatus 1 can reduce power consumption by standing by in a state where the trigger NAN function is enabled.

As described above, the controller 10 may include the transmission processing section 10c. The transmission processing section 10c transmits state information indicating the state of the first electronic apparatus 1 to the second electronic apparatus 2 via the second communication section 15. The state information indicates the current coupling standby state of the first electronic apparatus 1. Specifically, the state information is information indicating whether the first electronic apparatus 1 stands by for the Wi-Fi Aware coupling or stands by in a state where the trigger NAN function is enabled. If the state information indicates that the first electronic apparatus 1 stands by for the Wi-Fi Aware coupling, the state information indicates that the first electronic apparatus 1 stands by with Wi-Fi Aware. If the state information indicates the first electronic apparatus 1 stands by in a state where the trigger NAN function is enabled, the state information indicates that the first electronic apparatus 1 stands by with Bluetooth Low Energy Triggers NAN. Alternatively, for example, the state information may indicate whether the first electronic apparatus 1 is in the first state or the second state, as long as the second electronic apparatus 2 can interpret the state information indicating which standby state the first electronic apparatus 1 is in.

The timing of the transmission of the state information is, of course, a timing at which communication with the second electronic apparatus 2 via the second communication section 15 is possible. For example, the transmission processing section 10c may periodically transmit the state information from the first electronic apparatus 1 to the second electronic apparatus 2 via the second communication section 15.

More specifically, the transmission processing section 10c may transmit a Bluetooth Low Energy beacon including the information indicating the current coupling standby state of the first electronic apparatus 1 to the second electronic apparatus 2 from the second communication section 15. The second electronic apparatus 2 that has received the state information can determine the state of the first electronic apparatus 1 based on the state information. That is, by receiving the state information, the second electronic apparatus 2 can determine which of the apparatuses needs to make a coupling request, and can efficiently perform coupling.

### Configuration of Second Electronic Apparatus 2

As illustrated in FIG. 1, the second electronic apparatus 2 may include a controller 20, a storage section 21, a display section 22, an operation section 23, a first communication section 24, and a second communication section 25.

The controller 20 has a function of executing processing of performing Wi-Fi Aware communication with the first electronic apparatus 1 via the first communication section 24. Further, in a case where the controller 10 includes the transmission processing section 10c, the controller 20 may include a reception processing section 20c that receives, via the second communication section 25, the state information transmitted in transmission processing by the transmission processing section 10c.

The controller 20 may have functions equivalent to those of the state determination section 10a, the standby processing section 10b, and the transmission processing section 10c in order to execute processing of performing the Wi-Fi Aware communication with the first electronic apparatus 1 via the first communication section 24 in accordance with a coupling request from the first electronic apparatus 1. However, since this is only an explanation of the first electronic apparatus 1 and the second electronic apparatus 2 being replaced with each other, only an example in which the first electronic apparatus 1 in the standby state establishes the Wi-Fi Aware communication in accordance with a coupling request from the second electronic apparatus 2 will be described.

Similarly to the controller 10, the controller 20 may include, for example, an arithmetic processing device, a working memory, and a storage device that stores a control program, parameters, and the like. The controller 20 may be configured as an SoC. As can be seen from these examples, the controller 20 may be configured to store the control program in an executable state. However, the controller 20 may be configured to store the control program as a circuit configuration such as an FPGA, or may be configured as a dedicated circuit.

A function of executing processing of performing the Wi-Fi Aware communication with the first electronic apparatus 1 via the first communication section 24, and the reception processing section 20c can be implemented as the above-described program. The above-described program may include a program for the arithmetic processing device to implement the above-described functions and the function of the reception processing section 20c in cooperation with the storage section 21, the display section 22, the operation section 23, the first communication section 24, and the second communication section 25.

Similarly to the storage section 11, the storage section 21 is, for example, a storage device such as a hard disk drive, a solid state drive, or another memory. The storage section 21 can store, for example, setting information necessary for processing in the controller 20, information to be transmitted to the first electronic apparatus 1, and the like.

The configurations of the display section 22, the operation section 23, the first communication section 24, and the second communication section 25 are basically the same as the configurations of the display section 12, the operation section 13, the first communication section 14, and the second communication section 15 in the first electronic apparatus 1, respectively, and a description thereof will be omitted.

For example, the display section 22 is a section for displaying a UI image for operating the second electronic apparatus 2. The operation section 23 receives an operation performed by a user of the second electronic apparatus 2. However, due to the difference in structure between the second electronic apparatus 2 and the first electronic apparatus 1, the display section 22 and the operation section 23 are different from the display section 12 and the operation section 13, respectively, at least in terms of shape. The first communication section 24 is configured to communicate with the first communication section 14 of the first electronic apparatus 1 by the Wi-Fi Aware communication. The second communication section 25 is configured to communicate with the second communication section 15 of the first electronic apparatus 1 by Bluetooth Low Energy communication.

For example, the controller 20 requests, via the first communication section 24, the first electronic apparatus 1 to establish the Wi-Fi Aware coupling. Alternatively, the controller 20 requests, by the Bluetooth Low Energy communication via the second communication section 25, the first electronic apparatus 1 to establish the Wi-Fi Aware coupling.

Alternatively, in preparation for the case where the first electronic apparatus 1 is in the first state, the controller 20 first requests, via the first communication section 24, the first electronic apparatus 1 to establish the Wi-Fi Aware coupling. Then, when the second electronic apparatus 2 does not receive a response to the request within a predetermined period of time, the controller 20 requests, by the Bluetooth Low Energy communication via the second communication section 25, the first electronic apparatus 1 to establish the Wi-Fi Aware coupling in preparation for the case where the first electronic apparatus 1 is in the second state.

Alternatively, in preparation for the case where the first electronic apparatus 1 is in the second state, the controller 20 first requests, by the Bluetooth Low Energy communication via the second communication section 25, the first electronic apparatus 1 to establish the Wi-Fi Aware coupling. Then, when the second electronic apparatus 2 does not receive a response to the request within a predetermined period of time, the controller 20 requests, via the first communication section 24, the first electronic apparatus 1 to establish the Wi-Fi Aware coupling in preparation for the case where the first electronic apparatus 1 is in the first state.

As described above, when the second electronic apparatus 2 attempts to be coupled to the first electronic apparatus 1, the first electronic apparatus 1 stands by in a state where the trigger NAN function is enabled, and thus it is possible to reduce power consumption in the first electronic apparatus 1.

Alternatively, in a case where the controller 20 includes the reception processing section 20c, the reception processing section 20c may receive, via the second communication section 25, the state information transmitted from the first electronic apparatus 1. Then, the reception processing section 20c determines the state of the first electronic apparatus 1 based on the received state information. Further, when the state information indicates that the first electronic apparatus 1 stands by for the Wi-Fi Aware coupling, the reception processing section 20c requests, via the first communication section 24, the first electronic apparatus 1 to establish the Wi-Fi Aware coupling. On the other hand, when the state information indicates that the first electronic apparatus 1 stands by in a state where the trigger NAN function is enabled, the reception processing section 20c requests, by the Bluetooth Low Energy communication via the second communication section 25, the first electronic apparatus 1 to establish the Wi-Fi Aware coupling.

With the above-described configuration, the second electronic apparatus 2 can efficiently request the first electronic apparatus 1 to establish the coupling.

### Example of Communication Process

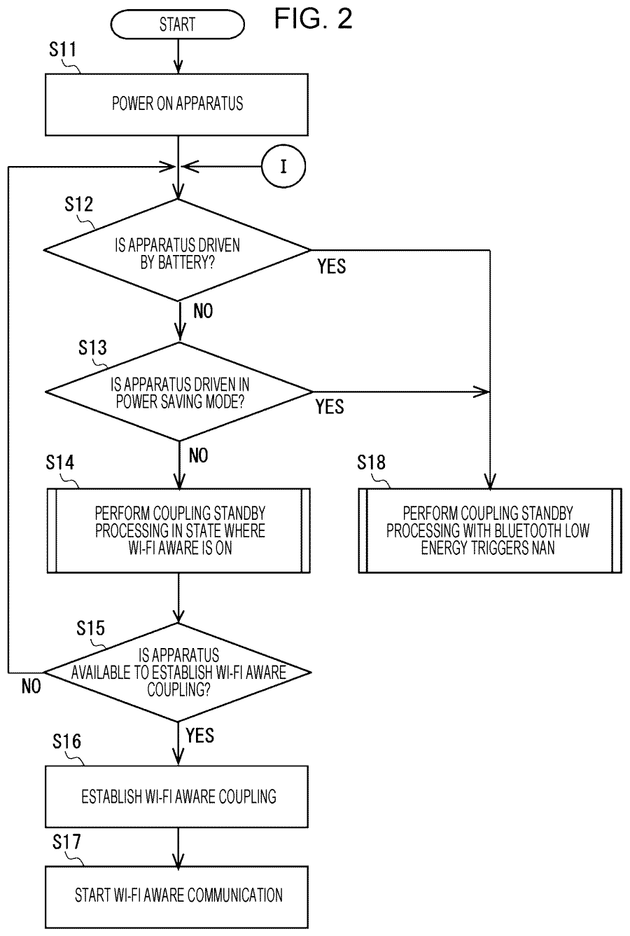

An example of a communication process executed in the communication system 100 having the above-described configuration will be described with reference to FIG. 2. FIG. 2 is a flowchart for explaining the example of the communication process.

In the example described here, description will be given on the assumption that the first electronic apparatus 1 is configured to be driven by a commercial power supply and a built-in battery. A state where the first electronic apparatus 1 is driven by the commercial power supply refers to a state where the first electronic apparatus 1 is driven by a so-called alternating current (AC) power supply.

In this example, the second state is a state where the first electronic apparatus 1 is driven by the commercial power supply in a power saving mode, and the first state is a state where the first electronic apparatus 1 is driven by the commercial power supply in a non-power saving mode in which power consumption is higher than in the power saving mode. The non-power saving mode may be, for example, a normal power mode, and may also be referred to as a normal mode.

First, the first electronic apparatus 1 is powered on by a user operation from the operation section 13 (step S11). Next, the state determination section 10a determines whether the first electronic apparatus 1 is driven by the battery (step S12).

If the answer is NO in step S12, the state determination section 10a determines whether the first electronic apparatus 1 is driven in the power saving mode (step S13). Whether the first electronic apparatus 1 is driven in the power saving mode or in the non-power saving mode may be set by a user operation from the operation section 13 or the external apparatus, or the first electronic apparatus 1 may automatically shift from the non-power saving mode to the power saving mode when the first electronic apparatus 1 is not operated for a predetermined time. In addition, the first electronic apparatus 1 may configured such that the predetermined time can be set by a user operation from the operation section 13 or the external apparatus.

As described above, when the first electronic apparatus 1 is powered on, the first electronic apparatus 1 checks a power supply source and the power mode, and switches the operation as follows in accordance with the checked power supply source and the checked power mode.

If the answer is NO in step S13, the standby processing section 10b executes coupling standby processing in a state where Wi-Fi Aware is on (step S14). On the other hand, if the answer is YES in step S12 or if the answer is YES in step S13, standby processing section 10b executes coupling standby processing with Bluetooth Low Energy Triggers NAN (step S18). The order of the processing in step S12 and step S13 may be reversed.

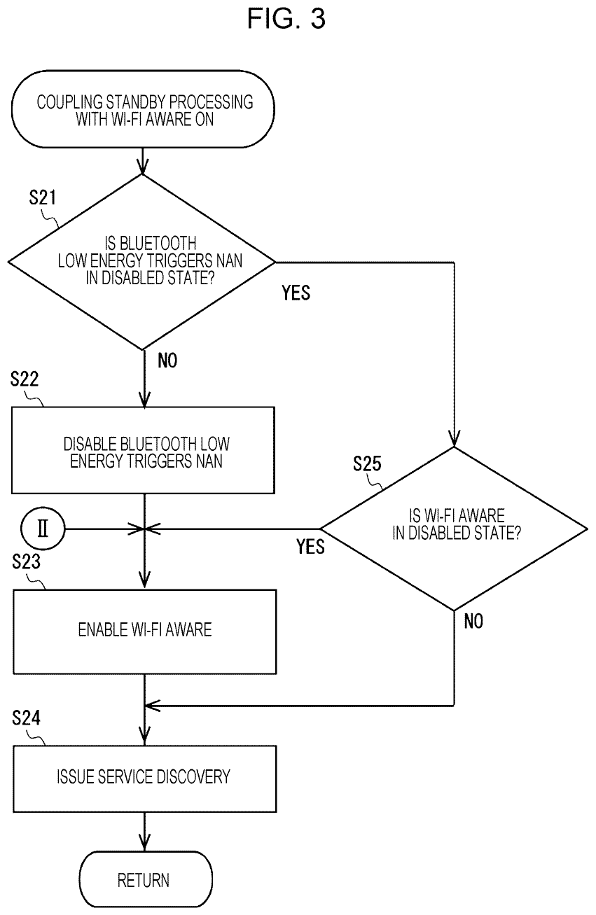

After the processing in step S14, the standby processing section 10b determines whether the first electronic apparatus 1 is available to establish the Wi-Fi Aware coupling (step S15). This determination can be made based on whether the first electronic apparatus 1 has received a request for the Wi-Fi Aware coupling from the second electronic apparatus 2. An example of the determination in step S15 after the processing in step S14 will be described later with reference to FIG. 3. As will be described later, the processing in step S18 includes a similar determination to that in step S15.

If the answer is NO in step S15, the process returns to step S12. On the other hand, if the answer is YES in step S15, the standby processing section 10b establishes the Wi-Fi Aware coupling (step S16). The establishment of the Wi-Fi Aware coupling refers to establishment of a NAN data link between the first electronic apparatus 1 and the second electronic apparatus 2, that is, establishment of a communication path and a service link by NAN between the first electronic apparatus 1 and the second electronic apparatus 2. After step S16, the controller 10 starts Wi-Fi Aware communication via the first communication section 14 (step S17). Thereafter, this communication may continue until the service link and the communication path are decoupled. When the service link and the communication path are decoupled, the process may return to step S12, for example.

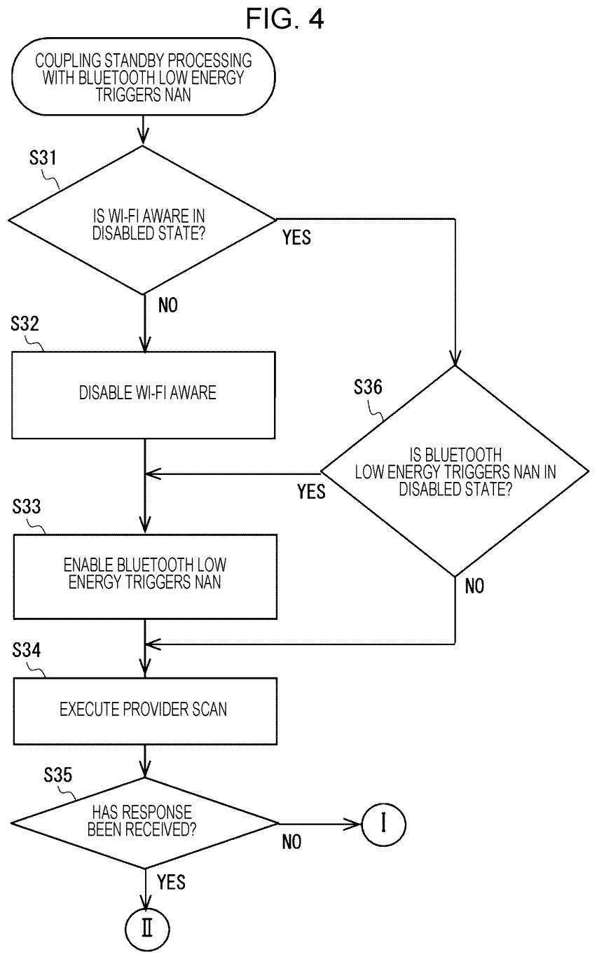

Next, specific examples of the processing in steps S14 and S18 will be described with reference to FIGS. 3 and 4. FIG. 3 is a flowchart for explaining an example of the coupling standby processing in a state where Wi-Fi Aware is on in the communication process illustrated in FIG. 2. FIG. 4 is a flowchart for explaining an example of the coupling standby processing with Bluetooth Low Energy Triggers NAN in the communication processing illustrated in FIG. 2.

In step S14, as illustrated in FIG. 3, first, the standby processing section 10b determines whether Bluetooth Low Energy Triggers NAN is in a disabled state, that is, whether the trigger NAN function is in a disabled state (step S21). If the answer is NO in step S21, the standby processing section 10b controls the second communication section 15 so as to disable the trigger NAN function (step S22). Next, the standby processing section 10b enables the Wi-Fi Aware function by turning on the Wi-Fi Aware function (step S23).

Then, the standby processing section 10b issues a service discovery from the first communication section 14 by the Wi-Fi Aware function (step S24), and ends the process.

On the other hand, if the answer is YES in step S21, the standby processing section 10b determines whether the Wi-Fi Aware function is in a disabled state (step S25). If the answer is YES in step S25, the process proceeds to step S23, and the Wi-Fi Aware function is enabled. If the answer is NO in step S25, the process proceeds to step S24, and the service discovery is issued by the Wi-Fi Aware function.

The standby processing section 10b can determine whether the first electronic apparatus 1 is available to establish the Wi-Fi Aware coupling in step S15, by determining whether or not the first electronic apparatus 1 receives a response to the service discovery issued in step S24 within a predetermined period of time. This response may refer to a follow-up. As in this example, when the Wi-Fi Aware coupling is not established between the first electronic apparatus 1 and the second electronic apparatus 2, for example, when the Wi-Fi Aware coupling is not established within a predetermined period of time, the state determination section 10a may determine whether the first electronic apparatus 1 is in the first state or the second state.

In step S18, as illustrated in FIG. 4, first, the standby processing section 10b determines whether Wi-Fi Aware is in a disabled state, that is, whether the Wi-Fi Aware function is in the disabled state (step S31). If the answer is NO in step S21, the standby processing section 10b controls the first communication section 14 so as to disable the Wi-Fi Aware function (step S32). Next, the standby processing section 10b enables the trigger NAN function by turning on the trigger NAN function (step S33).

Then, the standby processing section 10b executes a provider scan from the second communication section 15 by the trigger NAN function (step S34). Next, the standby processing section 10b determines whether the first electronic apparatus 1 receives a response within a predetermined period of time (step S35). This response may refer to a provider scan hit.

If the answer is NO in step S35, the process returns to step S12 in FIG. 2. Also in this example, when the Wi-Fi Aware coupling is not established between the first electronic apparatus 1 and the second electronic apparatus 2, for example, when the Wi-Fi Aware coupling is not established within a predetermined period of time, the state determination section 10a determines whether the first electronic apparatus 1 is in the first state or the second state. On the other hand, if the answer is YES in step S35, the process proceeds to step S23 in FIG. 3.

If the answer is YES in step S31, the standby processing section 10b determines whether the trigger NAN function is in the disabled state (step S36). If the answer is YES in step S36, the process proceeds to step S33, and the trigger NAN function is enabled. As in this example, when the first electronic apparatus 1 is in the second state, the standby processing section 10b may determine whether the trigger NAN function is enabled or disabled, and may enable the trigger NAN function if the trigger NAN function is disabled. If the answer is NO in step S36, the process proceeds to step S34, and the provider scan is executed by the trigger NAN function.

In the above-described communication process, the transmission of the state information may be executed, for example, at the time of the determination in steps S21, S25, S31, and S36, after the processing in step S23, and after the processing in step S33.

As described above with respect to the communication process in the first electronic apparatus 1, the first electronic apparatus 1 can stand by with the trigger NAN function that operates with lower power consumption. Therefore, for example, it is possible to prevent the first electronic apparatus 1 from standing by in a state where Wi-Fi is enabled during the execution of service discovery, and to reduce power consumption during the standby.

That is, according to the present embodiment, in the first electronic apparatus 1, it is possible to reduce power consumption in the standby state for performing the Wi-Fi Aware coupling to the second electronic apparatus 2 which is the other electronic apparatus. In particular, when the first electronic apparatus 1 is driven by the battery, improvement in battery duration can also be expected.

Since the above-described example indicates a state where the first electronic apparatus 1 is driven by the commercial power supply in the first state and the second state, the above-described example can be similarly applied to an example in which the first electronic apparatus 1 is configured to be driven only by the commercial power supply. In this case, the determination in step S12 is excluded from the process illustrated in FIG. 2.

The definitions of the first state and the second state are not limited to the example described above. For example, the second state may be a state where the first electronic apparatus 1 is driven in the power saving mode, and the first state may be a state where the first electronic apparatus 1 is driven in the non-power saving mode in which power consumption is higher than in the power saving mode. In this example, it does not matter whether the first electronic apparatus 1 is configured to be driven by the commercial power supply and the built-in battery or is configured to be driven by only one of the commercial power supply and the built-in battery.

Alternatively, the second state may be a state where the first electronic apparatus 1 is driven by the battery, and the first state may be a state where the first electronic apparatus 1 is driven by the commercial power supply. In this example, it is assumed that the first electronic apparatus 1 is configured to be driven by the commercial power supply and the built-in battery.

Although not particularly described, in the first electronic apparatus 1, when the controller 10 receives a user operation for enabling the Wi-Fi Aware function from the operation section 13 or the external apparatus, or when the first electronic apparatus 1 is powered on, Wi-Fi Aware may be automatically activated. In the first electronic apparatus 1, in order to further save power, when the controller 10 receives a user operation for enabling Wi-Fi Aware from the operation section 13 or the external apparatus, or when the first electronic apparatus 1 is powered on, trigger NAN may be automatically activated. In this case, Wi-Fi Aware is not activated.

Note that Wi-Fi Aware refers to, for example, a program for implementing the Wi-Fi Aware function in the first electronic apparatus 1 and an API used for exchanging information between the program and the first communication section 14 that is hardware for Wi-Fi Aware. API is an abbreviation for Application Programming Interface. In addition, trigger NAN refers to, for example, a program for implementing the trigger NAN function in the first electronic apparatus 1 and an API used for exchanging information between the program and the second communication section 15 that is hardware for Wi-Fi Aware.

### Other Modifications

The present disclosure is not limited to the above-described embodiments, and can be appropriately modified without departing from the scope of the present disclosure. For example, the electronic apparatuses may be any apparatuses as long as the apparatuses can implement the functions described above.

In addition, as exemplified above with respect to the procedure of the communication process, the present disclosure includes an aspect of a communication method executed by the first electronic apparatus 1 including the first communication section 14 that communicates with the second electronic apparatus 2 by the Wi-Fi Aware communication. In this communication method, when the first electronic apparatus 1 is in the first state related to power consumption, the first electronic apparatus 1 stands by for coupling in a state where the Wi-Fi Aware function is enabled. Next, when the first electronic apparatus 1 is in the second state predetermined as a state where power consumption is to be reduced more than in the first state, the first electronic apparatus 1 stands by for coupling in a state where the Bluetooth Low Energy Triggers NAN function is enabled. Then, when the first electronic apparatus 1 acquires the request to activate the Wi-Fi Aware function, the first electronic apparatus 1 stands by for coupling in a state where the Wi-Fi Aware function is enabled. Thereafter, when the Wi-Fi Aware coupling by the Wi-Fi Aware function is established between the first electronic apparatus 1 and the second electronic apparatus 2, the first electronic apparatus 1 executes the Wi-Fi Aware communication by the first communication section 14. Other application examples of this communication method are the same as those described for the communication system 100, and a description thereof will be omitted.

As described above with respect to the implementation with the program, the present disclosure includes an aspect of a program that causes a computer included in the first electronic apparatus 1 including the first communication section 14 that communicates with the second electronic apparatus 2 by the Wi-Fi Aware communication to execute the process of the above-described communication method. The process by this program and other application examples are the same as those described for the communication system 100, and a description thereof will be omitted.

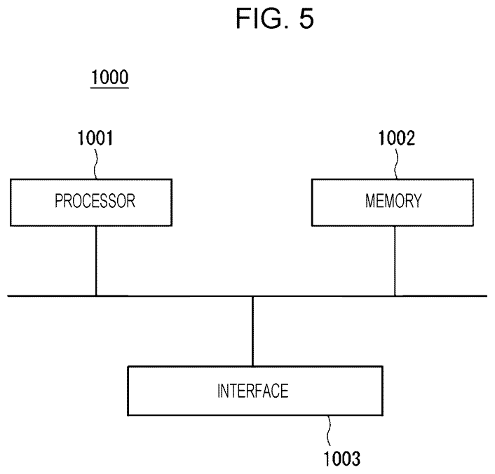

Further, each of the apparatuses included in the communication system according to the above-described embodiments may have, for example, the following hardware configuration. In this case, the apparatuses refer to the first electronic apparatus 1 and the second electronic apparatus 2 in the example illustrated in FIG. 1. FIG. 5 is a diagram illustrating an example of a hardware configuration of each of the apparatuses.

An apparatus 1000 illustrated in FIG. 5 may include a processor 1001, a memory 1002, and an interface 1003. The interface 1003 may include, for example, a communication interface and an interface with an input and output device, which are necessary depending on the apparatus.

The processor 1001 may be, for example, a CPU, a GPU, or a microprocessor unit (MPU) that is also referred to as a microprocessor. The processor 1001 may include a plurality of processors. The memory 1002 is constituted by, for example, a combination of a volatile memory and a nonvolatile memory. The functions in each of the apparatuses are implemented by the processor 1001 reading a program stored in the memory 1002 and executing the read program while exchanging necessary information via the interface 1003. For example, in a case where the apparatus 1000 is the first electronic apparatus 1, the program may include a program for causing the processor 1001 to execute the communication process including the standby processing as described above. For example, in a case where the apparatus 1000 is the second electronic apparatus 2, the program may include a program for causing the processor 1001 to execute the communication process including the processing of making a coupling request as described above.

In addition, the above-described program includes an instruction group (or software code) for causing the computer to perform one or more of the functions described in the embodiments when the program is read by the computer. The program may be stored in a non-transitory computer-readable medium or a tangible storage medium. By way of example, and not limitation, examples of the non-transitory computer-readable medium or the tangible storage medium include a random-access memory (RAM), a read-only memory (ROM), a flash memory, and a solid-state drive (SSD), or other memory technologies. Also by way of example, and not limitation, examples of the non-transitory computer-readable medium or the tangible storage medium include a CD-ROM, a digital versatile disc (DVD), a Blu-ray (registered trademark) disc or other optical disc storage, a magnetic cassette, magnetic tape, and magnetic disk storage or another magnetic storage device. The program may be transmitted on a transitory computer-readable medium or a communication medium. By way of example, and not limitation, examples of the transitory computer-readable medium or the communication medium include electrical, optical, acoustical, or other forms of propagated signals.

Although the present disclosure has been described with reference to the above-described embodiments, the present disclosure is not limited to the configurations described in the above-described embodiments, and it goes without saying that the present disclosure includes various modifications, corrections, and combinations that can be made by those skilled in the art within the scope of the claims of the present application.

What is claimed is:

1. An electronic apparatus comprising:
a communication section that communicates with another electronic apparatus by Wi-Fi Aware communication; and
a controller, wherein
the controller
stands by for coupling in a state where a Wi-Fi Aware function is enabled when the electronic apparatus is in a first state related to power consumption,
stands by for coupling in a state where a Bluetooth Low Energy Triggers Neighbor Awareness Networking (NAN) function is enabled when the electronic apparatus is in a second state predetermined as a state where power consumption is to be reduced more than in the first state, and stands for coupling in a state where the Wi-Fi Aware function is enabled when the electronic apparatus acquires a request to activate the Wi-Fi Aware function, and
the communication section executes the Wi-Fi Aware communication when Wi-Fi Aware coupling by the Wi-Fi Aware function is established between the electronic apparatus and the other electronic apparatus.

2. The electronic apparatus according to claim 1, wherein
the second state is a state where the electronic apparatus is driven in a power saving mode, and
the first state is a state where the electronic apparatus is driven in a non-power saving mode in which power consumption is higher than in the power saving mode.

3. The electronic apparatus according to claim 1, wherein
the second state is a state where the electronic apparatus is driven by a battery, and
the first state is a state where the electronic apparatus is driven by a commercial power supply.

4. The electronic apparatus according to claim 1, wherein
the second state is a state where the electronic apparatus is driven by a commercial power supply in a power saving mode, and
the first state is a state where the electronic apparatus is driven by the commercial power supply in a non-power saving mode in which power consumption is higher than in the power saving mode.

5. The electronic apparatus according to claim 1, wherein
the controller
determines whether the Bluetooth Low Energy Triggers NAN function is enabled or disabled when the electronic apparatus is in the second state, and
enables the Bluetooth Low Energy Triggers NAN function if the Bluetooth Low Energy Triggers NAN function is disabled.

6. The electronic apparatus according to claim 1, wherein
when the Wi-Fi Aware coupling is not established between the electronic apparatus and the other electronic apparatus, the controller determines whether the electronic apparatus is in the first state or the second state.

7. The electronic apparatus according to claim 1, wherein
the controller transmits, to the other electronic apparatus, a Bluetooth Low Energy beacon including information indicating a current coupling standby state of the electronic apparatus.

8. A communication method comprising:
causing an electronic apparatus including a communication section that communicates with another electronic apparatus by Wi-Fi Aware communication to:
stand by for coupling in a state where a Wi-Fi Aware function is enabled when the electronic apparatus is in a first state related to power consumption;
stand by for coupling in a state where a Bluetooth Low Energy Triggers Neighbor Awareness Networking (NAN) function is enabled when the electronic apparatus is in a second state predetermined as a state where power consumption is to be reduced more than in the first state, and stand by for coupling in a state where the Wi-Fi Aware function is enabled when the electronic apparatus acquires a request to activate the Wi-Fi Aware function; and
cause the communication section to execute the Wi-Fi Aware communication when Wi-Fi Aware coupling by the Wi-Fi Aware function is established between the electronic apparatus and the other electronic apparatus.

9. A non-transitory computer-readable storage medium storing a program that causes a computer included in an electronic apparatus including a communication section that communicates with another electronic apparatus by Wi-Fi Aware communication to execute a process of:
causing the electronic apparatus to stand by for coupling in a state where a Wi-Fi Aware function is enabled when the electronic apparatus is in a first state related to power consumption;
causing the electronic apparatus to stand by for coupling in a state where a Bluetooth Low Energy Triggers Neighbor Awareness Networking (NAN) function is enabled when the electronic apparatus is in a second state predetermined as a state where power consumption is to be reduced more than in the first state, and stand by for coupling in a state where the Wi-Fi Aware function is enabled when the electronic apparatus acquires a request to activate the Wi-Fi Aware function; and
causing the communication section to execute the Wi-Fi Aware communication when Wi-Fi Aware coupling by the Wi-Fi Aware function is established between the electronic apparatus and the other electronic apparatus.
